(19) United States
(12) Patent Application Publication
(10) Pub. No.: US 2021/0192557 A1
(43) Pub. Date: Jun. 24, 2021

(54) DYNAMIC CARPOOL DISCOUNT DETERMINATION ON RIDESHARING PLATFORMS

(71) Applicant: Beijing DiDi Infinity Technology and Development Co., Ltd., Beijing (CN)

(72) Inventor: Bo TAN, Sunnyvale, CA (US)

(21) Appl. No.: 17/082,607

(22) Filed: Oct. 28, 2020

Related U.S. Application Data
(60) Provisional application No. 62/950,203, filed on Dec. 19, 2019.

(51) Int. Cl. G06Q 30/02; G06Q 50/30; G06N 7/00; G06N 20/00

(52) U.S. Cl. CPC G06Q 30/0207; G06Q 30/0283; G06N 20/00; G06N 7/005; G06Q 50/30

(57) ABSTRACT

Dynamic carpool discounts may be determined on ridesharing platforms. Trip information of a first rider in a carpool trip on a ridesharing platform may be obtained. A matching probability of matching the carpool trip with at least one second rider may be determined. An upfront discount and a fallback discount may be determined based on a matching probability and the trip information. It may be determined whether the at least one second rider matches with the carpool trip during the carpool trip. A final price for the first rider may be determined based on the upfront discount in response to determining that the carpool trip matches with the at least one second rider. A final price for the first rider may be determined based on the fallback discount in response to determining that the carpool trip does not match with the at least one second rider.

### CROSS-REFERENCE TO RELATED APPLICATION

This application claims the benefit of U.S. Provisional Patent Application No. 62/950,203, filed on Dec. 19, 2019. The entirety of the aforementioned application is incorporated herein by reference.

### TECHNICAL FIELD

The disclosure relates generally to dynamic carpool discount determination on ridesharing platforms.

### BACKGROUND

Ridesharing platforms may match drivers of personal cars or taxis with riders to provide on-demand transportation services. A rider may also be matched with co-riders who travel along similar routes to form a carpooling trip. Carpooling may be very important for cities because it may result in less traffic congestion. Carpooling may also achieve more financial efficiency for the ridesharing platform itself, as cost savings may be obtained through a higher utilization of car resources and drivers' supply hours. Effective carpooling may reduce the cost compared to moving the same amount of riders and demand on a platform without carpooling.

### SUMMARY

Various embodiments of the specification include, but are not limited to, systems, methods, and non-transitory computer readable media for dynamic carpool discount determination.

In various implementations, a method may include obtaining trip information of a first rider in a carpool trip on a ridesharing platform and determining a matching probability of matching the carpool trip with at least one second rider. The method may further include determining an upfront discount and a fallback discount based on a matching probability and the trip information. The method may further include determining whether the at least one second rider matches with the carpool trip. If the carpool trip matches with the at least one second rider, a final price for the first rider may be determined based on the upfront discount. If the carpool trip does not match with the at least one second rider, a final price for the first rider may be determined based on the fallback discount.

In another aspect of the present disclosure, a computing system may comprise one or more processors and one or more non-transitory computer-readable memories coupled to the one or more processors and configured with instructions executable by the one or more processors. Executing the instructions may cause the system to perform operations. The operations may include obtaining trip information of a first rider in a carpool trip on a ridesharing platform and determining a matching probability of matching the carpool trip with at least one second rider. The operations may further include determining an upfront discount and a fallback discount based on a matching probability and the trip information. The operations may further include determining whether the at least one second rider matches with the carpool trip. If the carpool trip matches with the at least one second rider, a final price for the first rider may be determined based on the upfront discount. If the carpool trip does not match with the at least one second rider, a final price for the first rider may be determined based on the fallback discount.

Yet another aspect of the present disclosure is directed to a non-transitory computer-readable storage medium configured with instructions executable by one or more processors to cause the one or more processors to perform operations. The operations may include obtaining trip information of a first rider in a carpool trip on a ridesharing platform and determining a matching probability of matching the carpool trip with at least one second rider. The operations may further include determining an upfront discount and a fallback discount based on a matching probability and the trip information. The operations may further include determining whether the at least one second rider matches with the carpool trip. If the carpool trip matches with the at least one second rider, a final price for the first rider may be determined based on the upfront discount. If the carpool trip does not match with the at least one second rider, a final price for the first rider may be determined based on the fallback discount.

In some embodiments, the trip information may include at least one of a time of the carpool trip, an origin region of the first rider in the carpool trip, a destination region of the first rider in the carpool trip, a route of the carpool trip, a rider profile of the first rider, and points of interest. In some embodiments, the rider profile may include a number of years the rider has been using the app, a most frequent payment method the rider used, a phone type such as android or iOS, how frequently the ride has been using the app, a historical number of rider hailing trips (solo and/or carpool) the rider has taken, a historical number of carpool trips the rider has taken, a historical distance traveled during carpool trips, and a historical distance traveled with one other rider, two other riders, etc. in the vehicle. In some embodiments, the rider profile may excluding sensitive information (e.g., gender, age and race).

In some embodiments, the fallback discount may include a preset minimum discount.

In some embodiments, the upfront discount may be determined based on the fallback discount, the matching probability, and an average discount.

In some embodiments, the upfront discount may be personalized for the first rider by a personalized ride conversion model trained based on a plurality of historical trips.

In some embodiments, determining the upfront discount may include generating, by the personalized ride conversion model, a price sensitivity curve comprising a conversion probability as a monotonically increasing function of discount. The upfront discount may be determined based on a targeted conversion probability and the price sensitivity curve.

In some embodiments, determining the matching probability may include training a machine learning model based on a plurality of historical trips, and inputting features from the trip information into the trained machine learning model. The matching probability may be determined from the trained machine learning model based on the input features.

In some embodiments, determining the matching probability further may include obtaining updated trip information during the carpool trip. The matching probability may be updated periodically based on inputting the updated trip information into the trained machine learning model. The fallback discount may be updated based on the updated matching probability.

In some embodiments, a solo trip price and an upfront price for the carpool trip may be displayed based on the upfront discount after the first rider selects an origin and a destination of the trip.

In some embodiments, a fallback price for the carpool trip may be displayed based on the fallback discount. A notification may be displayed informing the first rider that the fallback price will apply if the carpool trip does not match with the at least one second rider.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an exemplary system to which techniques for dynamic carpool discount determination may be applied, in accordance with various embodiments.

FIG. 2 illustrates a block diagram for determining the matching probability, according to various embodiments of the present disclosure.

FIG. 3 illustrates an example set of ride options, according to various embodiments of the present disclosure.

FIG. 4 illustrates a flowchart of an exemplary method, according to various embodiments of the present disclosure.

FIG. 5 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may dynamically determine a discount for a rider in a carpool trip on a ridesharing platform. Ridesharing platforms may use an upfront price for a rider fare in carpool-type ridesharing services. An upfront price for a carpool service may factor in estimated travel time and distance, supply/demand balance, carpool discount, and various surcharges and fees. In some embodiments, the supply/demand balance may be reflected as a surge multiplier. The carpool discount may be determined by pricing algorithms or may be set manually (e.g., by strategy & planning teams or local operations teams in ridesharing companies). Discounts may be provided for carpool riders because the carpool matching reduces cost for the ridesharing platform. The payout to drivers for moving the same amount of demand (i.e., riders) may be reduced as compared to solo trips. The saved cost may be partially or wholly used as subsidies (i.e., incentives, discounts) for riders in order to attract more rides.

However, if a carpool trip does not get matched, the expected efficiency may not be achieved (i.e., no cost savings). Subsidizing the rider may become an unnecessary expenditure for the platform. The commitment to providing the discount may unnecessarily cost the platform a large amount of money if the overall matching efficiency is low. Unnecessary cost may be limited by dynamically determining the discount to provide to riders. The experiences of riders may be taken into consideration to ensure the user experience is not compromised after fare uncertainty is increased.

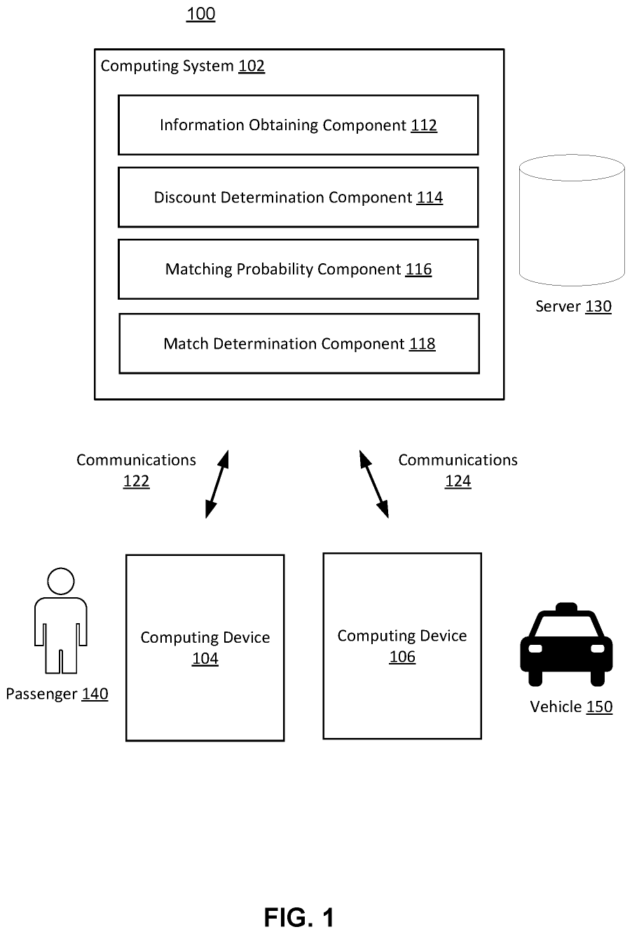

FIG. 1 illustrates an exemplary system 100 to which techniques for dynamic carpool discount determination may be applied, in accordance with various embodiments. The example system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers (e.g., server 130), or one or more clouds. The server 130 may include hardware or software which manages access to a centralized resource or service in a network. A cloud may include a cluster of servers and other devices that are distributed across a network.

The computing devices 104 and 106 may be implemented on or as various devices such as a mobile phone, tablet, server, desktop computer, laptop computer, etc. The computing devices 104 and 106 may each be associated with one or more vehicles (e.g., car, truck, boat, train, autonomous vehicle, electric scooter, electric bike, etc.). The computing devices 104 and 106 may each be implemented as an in-vehicle computer or as a mobile phone used in association with the one or more vehicles. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

In some embodiments, the system 100 may include a ridesharing platform. The ridesharing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ridesharing platform.

The computing system 102 may receive the request and reply with price quote data and price discount data for one or more trips. The price quote data and price discount data for one or more trips may be included in communications 122. When the passenger 140 selects a trip, the computing system 102 may relay trip information to various drivers of idle vehicles. The trip information may be included in communications 124. For example, the request may be posted to computing device 106 carried by the driver of vehicle 150, as well as other computing devices carried by other drivers. The driver of vehicle 150 may accept the posted transportation request. The acceptance may be sent to computing system 102 and may be included in communications 124. The computing system 102 may send match data to the passenger 140 through computing device 104. The match data may be included in communications 122. The match data may also be sent to the driver of vehicle 150 through computing device 106 and may be included in communications 124. The match data may include pick-up location information, fees, passenger information, driver information, and vehicle information. The matched vehicle may then be dispatched to the requesting passenger. The fees may include transportation fees and may be transacted among the system 102, the computing device 104, and the computing device 106. The fees may be included in communications 122 and 124. The communications 122 and 124 may additionally include observations of the status of the ridesharing platform.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. The computing system 102 may include an information obtaining component 112, a discount determination component 114, a matching probability component 116, and a match determination component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the system 100.

In some embodiments, the information obtaining component 112 may be configured to obtain information. The obtained information may include trip information of a first rider in a carpool trip on a ridesharing platform. Obtaining information may include one or more of accessing, acquiring, analyzing, determining, examining, identifying, loading, locating, opening, receiving, retrieving, reviewing, storing, or otherwise obtaining the information. In some embodiments, trip information may include at least one origin and destination selected by at least one rider. In some embodiments, the at least one origin may be based on a location of a mobile device of the rider requesting the route. In some embodiments, the at least one origin and destination may be selected by the rider through a ridesharing application. In some embodiments, the trip information may include features to be input into at least one machine learning model (e.g., time, location, route, rider profile, rider historical trip behaviors, points of interest, and other context information). In some embodiments, the trip information may be obtained from at least one feature store. In some embodiments, the rider profile may include a number of years the rider has been using the app, a most frequent payment method the rider used, a phone type such as android or iOS, how frequently the ride has been using the app, a historical number of rider hailing trips (both solo and carpool) the rider has taken, a historical number of carpool trips the rider has taken, a historical distance traveled during carpool trips, and a historical distance traveled with one other rider, two other riders, etc. in the vehicle. In some embodiments, the rider profile may excluding sensitive information (e.g., gender, age and race).

In some embodiments, the discount determination component 114 may be configured to obtain an upfront discount and a fallback discount based on a matching probability of matching the carpool trip with at least one second rider. In some embodiments, an upfront price may be displayed to the first rider in a ridesharing application based on the upfront discount after the rider selects an origin (e.g., location of the rider) and a destination of the trip. The upfront discount may be shown in addition to the whole upfront price. In some embodiments, a price of a trip in a solo mode may be shown along with the upfront price for the carpool trip. In some embodiments, the ridesharing application may include a detailed page showing the discount explicitly. In some embodiments, the ridesharing application may inform the rider that if there is no match, there will be another fallback discount which is smaller than offered in the upfront pricing stage.

In some embodiments, the two discounts may be determined based on the principle of “mean matching.” For example, the following equation may be used:

d̅:=E[D]=d₁·p+d₂·(1−p) (1)

wherein d is an expectation (i.e., mean, denoted as symbol E[*]) of a random variable D which represents the discount. The variables d₁ and d₂ may represent the upfront discount and the fallback discount respectively. The variable p may represent a matching probability of matching the first rider's carpool trip with at least one second rider.

In some embodiments, d̅ and p may be used as inputs to determine d₁ and d₂. The matching probability p may be estimated by the matching probability component 116 described in more detail below. In some embodiments, the mean discount d may be obtained based on a granular approach. For example, different mean discounts may be determined for different regions and time slots. In some embodiments, the mean discount d may be obtained based on a regional discount (e.g., city, county, district, state, country) or route-temporal discount. For example, the regional discount may include a predetermined value decided and set by a regional operation team. A route-temporal discount may include one discount value for each tuple (origin region, destination region, time slot). In some embodiments, the mean discount d may be obtained based on a route-temporal discount generated based on algorithms utilizing machine learning and optimization techniques.

In order to determine both d₁ and d₂, additional conditions or criterions may be added. In some embodiments, the fallback discount d₂ may be set at a minimum discount. The minimum discount may be based on the lowest price that can be offered in order to make the carpool mode an attractive product for price-sensitive users. Once d₂ is set, equation (1) may be used to determine the value of d₁. As a result, d₁ and d₂ may align with d (the average discount) in the pricing unit (e.g., city-wide unit, route-temporal unit).

In some embodiments, the upfront discount d₁ may be determined before d₂. The upfront discount d₁ may be personalized for the first rider. For example, historical trip data may be collected, and a personalized ride conversion model may be trained for each rider using machine learning techniques. The model may be trained based on either an offline or an online machine learning training pipeline. The machine learning model may include logistic regression, random forest, deep neural network, or another model. The features of the model may include discount, time, location, route, rider profile, rider historical trip behaviors and other context information Examples of other context information include weather (e.g., cold, raining) and events (e.g., sporting event, concert). In some embodiments, the rider profile may include a number of years the rider has been using the app, a most frequent payment method the rider used, a phone type such as android or iOS, how frequently the ride has been using the app, a historical number of rider hailing trips (both solo and carpool) the rider has taken, a historical number of carpool trips the rider has taken, a historical distance traveled during carpool trips, and a historical distance traveled with one other rider, two other riders, etc. in the vehicle. In some embodiments, the rider profile may excluding sensitive information (e.g., gender, age and race). These features may have underlying correlations with the probability of a rider's ride request being converted to a ride, and the trained personalized ride conversion model may learn these underlying correlations. In some embodiments, for an incoming ride request from a rider, the trained personalized ride conversion model may predict the corresponding conversion probability of the ride.

In some embodiments, the model may generate a price sensitivity curve during the prediction stage of machine learning by fixing feature values other than the discount. The price sensitivity curve may include a conversion probability as a monotonically increasing function of discount. A targeted conversion probability (e.g., 60%) may be set in order to determine a corresponding discount value as d₁. Once d₁ is determined, equation (1) may be used to determine the value of d₂. As a result, both d₁ and d₂ may be personalized to the rider.

In some embodiments, the matching probability component 116 may be configured to determine the matching probability of matching the carpool trip with at least one second rider. In some embodiments, machine learning may be used to predict the matching probability. In some embodiments, the prediction of the matching probability may be used as an input for the matching probability p used in determining d₁ and d₂. The machine learning model may include logistic regression, random forest, deep neural network, or another model. The features of the model may include discount, time, location, route, points of interest (POIs) and other context information. Examples of other context information include weather (e.g., cold, raining) and events (e.g., sporting events, concerts). The features of the model may additionally include historical trip counts along the original route and neighboring routes. A neighboring route may include a route of which the origin and destination are both within a certain distance of the origin and destination of the original route, respectively. The model may be trained either offline or online.

In some embodiments, the matching probability may be updated periodically. For example, the matching probability may be re-estimated after a certain time interval (e.g. 1 minute, 2 minutes) or travel distance (e.g., 1 km, 1 mile). In some embodiments, the features of the model may be stored in a low latency feature storage so that they are accessible in real-time (e.g., less than a minute, less than a second, less than a millisecond, etc.). The low latency feature storage may allow low-latency machine learning prediction to be achieved. For example, the matching probability component 116 may monitor the matching probability in a real-time fashion.

In some embodiments, the discount determination component 114 may further be configured to determine an updated value for fallback discount d₂ during a trip on the ridesharing platform. The updated value for fallback discount d₂ may be determined based on an updated probability p′. For example, p′ may be updated in real-time, and d₂ may be recalculated in real-time based on the real-time p′. The value for fallback discount d₂ may be updated if:

p′<p−δ, (2)

wherein p′ is the updated probability, p is the matching probability estimated before the trip, and δ is a predefined margin. The value for fallback discount d₂ may be re-evaluated by rearranging equation (1) as:

d₂=(d̅−d₁·p′)/(1−p′). (3)

In some embodiments, the updated value for fallback discount d₂ may be smaller than the previously calculated value for fallback discount d₂. If there is no match during the carpooling trip, less incentive may be provided to the rider to reduce costs for the ridesharing platform. The upfront discount d₁ may remain unchanged. If the first rider is matched with at least one second rider, the first rider may still receive the large discount offered to them before the trip. In some embodiments, re-evaluation may not be triggered when the in-trip estimated match probability increases. In this scenario, there is a higher chance for a match to occur. The rider incentive may be maintained because there is a higher chance that the platform will receive driver cost savings. The updated probability p′ may replace the old probability p after the value for fallback discount d₂ is updated, and the updated probability may be used when next re-evaluation of the fallback discount d₂ is triggered.

In some embodiments, the match determination component 118 may be configured to determining whether the at least one second rider matches with the carpool trip. If the carpool trip matches with the at least one second rider, a final price for the first rider may be determined based on the upfront discount. If the carpool trip does not match with the at least one second rider, a final price for the first rider may be determined based on the fallback discount. In some embodiments, a two-tier switch mode may be used to determine a dynamic discount. The final price after finishing the trip may depend on whether during the trip there are co-riders(s) matched. If there is at least one match, the final price may be an upfront price based on the upfront discount. Otherwise, the rider may be charged with a fallback price based on the fallback discount. The fallback price may be higher than the upfront price.

In some embodiments, the rider application may add an opt-in/opt-out option for this pricing strategy. This feature may result in an improved rider experience. A larger discount than the normal upfront discount d may be offered if the rider opts in. The opportunity to receive a larger discount may incentivize riders to opt in.

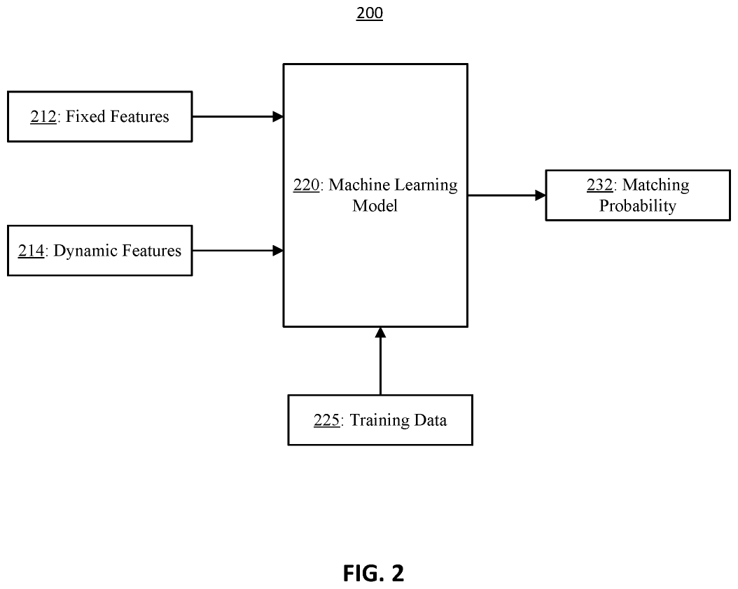

FIG. 2 illustrates a block diagram 200 for determining the matching probability, according to various embodiments of the present disclosure. The block diagram 200 may be implemented in various environments including, for example, the environment 100 of FIG. 1. The operations of the block diagram 200 presented below are intended to be illustrative. Depending on the implementation, the block diagram 200 may include additional, fewer, or alternative blocks in various orders or in parallel. The block diagram 200 may be implemented in various computing systems or devices including one or more processors.

In some embodiments, a set of inputs for determining carpool matching probabilities may be collected, including fixed features 212, and dynamic features 214. The fixed features 212 may include trip information collected when a rider requests a trip. The dynamic features 214 may include trip information which is updated during a trip. The inputs may be fed into the machine learning model 220. In some embodiments, the machine learning model 220 may be included in the matching probability component 116 of FIG. 1. In some embodiments, the machine learning model may be trained based on training data 225. For example, the machine learning model may be trained offline based on training data collected from a plurality of historical trips. The plurality of historical trips includes positive training samples (e.g., trips got matched) and negative training samples (e.g., trips didn't get matched), and each training sample comprises various features associated with the trip, such as features of the rider and/or driver of the trip, temporal and/or spatial information of the trip, discount information, weather condition, or other suitable information. After training, the machine learning model 220 may accept inputs such as features of a pending trip, and predict a matching probability 232 for the pending trip. In another example, the machine learning model 220 may receive feedback (e.g., newly collected positive or negative training samples) in real time (e.g., every minute, every hour, every day) and updated its parameters based on the feedback. In some embodiments, the matching probability 232 may be determined at the beginning of a trip, and may be updated during the trip based on the dynamic features 214. For example, updated trip information may be obtained periodically or in real-time during the carpool trip. The matching probability may be updated based on inputting the updated trip information into the trained machine learning model. Accordingly, the fallback discount may be updated based on the updated matching probability.

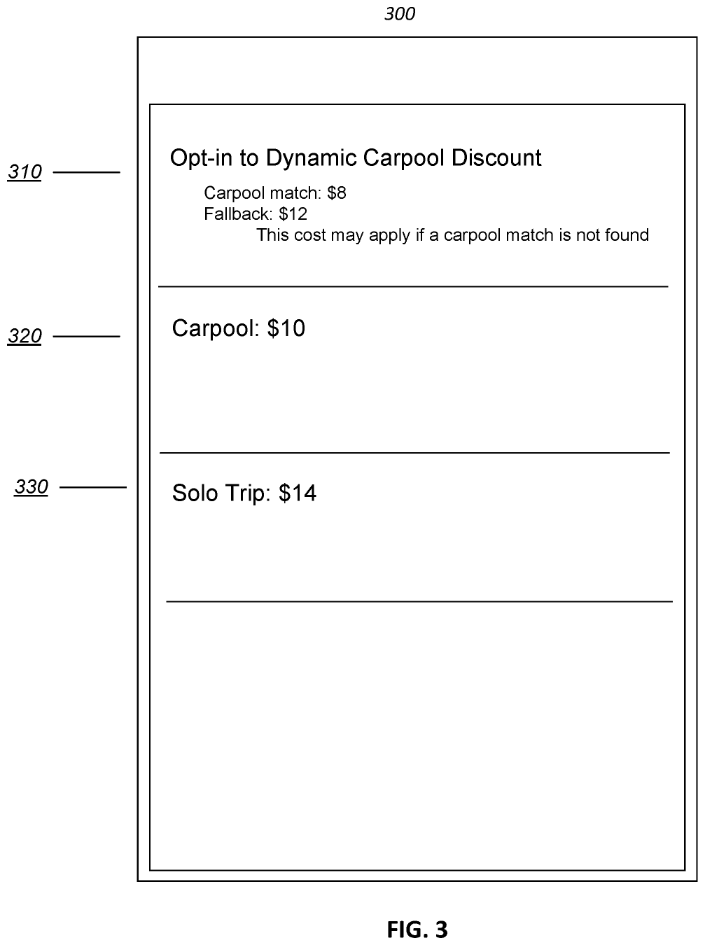

FIG. 3 illustrates an example set of ride options 300, according to various embodiments of the present disclosure. The set of ride options 300 may be stored on an electronic storage of the computing system 102, an electronic storage of a device accessible via a network (e.g., server), one of more client devices (e.g., desktop, laptop, smartphone, tablet, mobile device), or other locations. The set of ride options 300 includes opt-in 310, carpool 320, and solo trip 330. Opt-in 310 may include option to opt-in to receive a dynamic carpool discount. The dynamic carpool discount may be determined based on whether the rider matches with another carpool rider. Opt-in 310 may include a carpool match price (i.e., an upfront cost), a fallback price, and a disclaimer that the higher trip cost may apply if there is not a match. Carpool 320 may include an option to receive a fixed carpool price that will remain the same whether or not there is a match. The fixed carpool price may be higher than the carpool match price to incentivize riders to opt-in to the dynamic pricing. Solo trip 330 may include an option to take a solo trip without any carpool matching, and a price for the solo trip.

In some embodiments, the set of ride options 300 may be provided to a rider through an I/O interface. An I/O interface may comprise an auditory interface and a visual interface. For example, the set of ride options 300 may be played as audio using a speaker. In another example, the set of ride options 300 may be displayed on a Graphical User Interface (GUI). The GUI may be displayed on the screen of a user device. For example, the user device may be the same device on which computing system 102 is embodied.

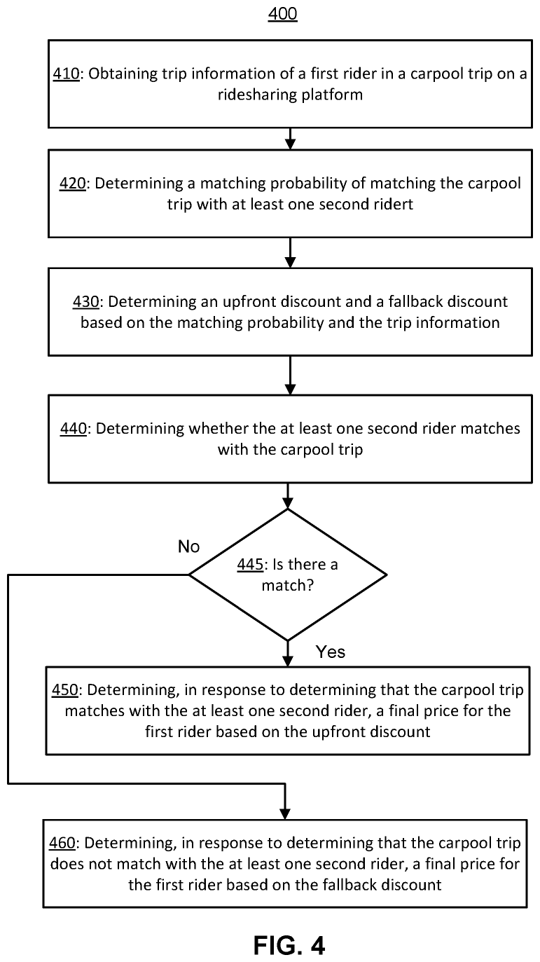

FIG. 4 illustrates a flowchart of an exemplary method 400, according to various embodiments of the present disclosure. The method 400 may be implemented in various environments including, for example, the system 100 of FIG. 1. The method 400 may be performed by computing system 102. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, trip information of a first rider in a carpool trip on a ridesharing platform may be obtained. At block 420, a matching probability of matching the carpool trip with at least one second rider may be determined. At block 430, an upfront discount and a fallback discount may be determined based on the matching probability and the trip information. At block 440, it may be determined whether the at least one second rider matches with the carpool trip. At block 445, if there is a match, the process may advance to block 450. If there is not a match, the process may advance to block 460. At block 450, a final price for the first rider may be determined based on the upfront discount in response to determining that the carpool trip matches with the at least one second rider. At block 460, a final price for the first rider may be determined based on the fallback discount in response to determining that the carpool trip does not match with the at least one second rider.

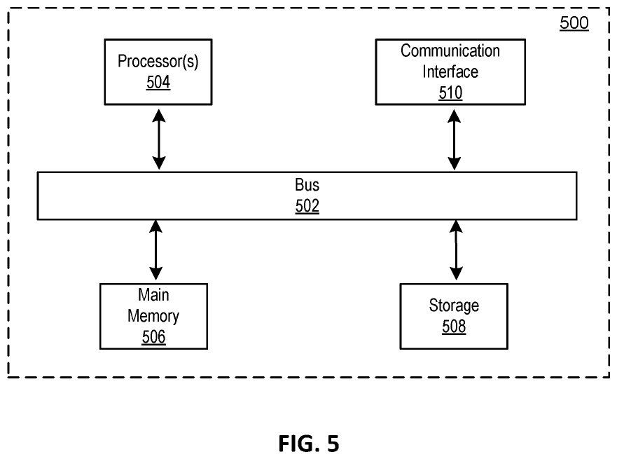

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102 or one or more components of the computing system 102 shown in FIG. 1. As another example, the process/method shown in FIG. 4 and described in connection with this figure may be implemented by computer program instructions stored in main memory 506. When these instructions are executed by processor(s) 504, they may perform the steps as shown in FIG. 4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method for dynamic carpool discount determination, comprising:
obtaining trip information of a first rider in a carpool trip on a ridesharing platform;
determining a matching probability of matching the carpool trip with at least one second rider;
determining an upfront discount and a fallback discount based on the matching probability and the trip information;
determining whether the at least one second rider matches with the carpool trip during the carpool trip;
determining, in response to determining that the carpool trip matches with the at least one second rider, a final price for the first rider based on the upfront discount; and
determining, in response to determining that the carpool trip does not match with the at least one second rider, a final price for the first rider based on the fallback discount.

2. The method of claim 1, wherein the trip information comprises at least one of a time of the carpool trip, an origin region of the first rider in the carpool trip, a destination region the first rider in the carpool trip, a route of the carpool trip, a rider profile of the first rider, and points of interest.

3. The method of claim 1, wherein the fallback discount comprises a preset minimum discount.

4. The method of claim 1, wherein the upfront discount is determined based on the fallback discount, the matching probability, and an average discount.

5. The method of claim 1, wherein the upfront discount is personalized for the first rider by a personalized ride conversion model trained based on a plurality of historical trips.

6. The method of claim 5, wherein determining the upfront discount comprises:
generating, by the personalized ride conversion model, a price sensitivity curve comprising a conversion probability as a monotonically increasing function of discount; and
determining the upfront discount based on a targeted conversion probability and the price sensitivity curve.

7. The method of claim 1, wherein determining the matching probability comprises:
training a machine learning model based on a plurality of historical trips;
inputting features from the trip information into the trained machine learning model; and
determining the matching probability from the trained machine learning model based on the input features.

8. The method of claim 7, wherein determining the matching probability further comprises:
obtaining updated trip information during the carpool trip;
updating the matching probability periodically based on inputting the updated trip information into the trained machine learning model; and
updating the fallback discount based on the updated matching probability.

9. The method of claim 1, further comprising:
displaying a solo trip price and an upfront price for the carpool trip based on the upfront discount after the first rider selects an origin and a destination of the trip.

10. The method of claim 1, further comprising:
displaying a fallback price for the carpool trip based on the fallback discount; and
displaying a notification informing the first rider that the fallback price will apply if the carpool trip does not match with the at least one second rider.

11. A system for dynamic carpool discount determination, comprising one or more processors and one or more non-transitory computer-readable memories coupled to the one or more processors and configured with instructions executable by the one or more processors to cause the system to perform operations comprising:
obtaining trip information of a first rider in a carpool trip on a ridesharing platform;
determining a matching probability of matching the carpool trip with at least one second rider;
determining an upfront discount and a fallback discount based on the matching probability and the trip information;
determining whether the at least one second rider matches with the carpool trip during the carpool trip;
determining, in response to determining that the carpool trip matches with the at least one second rider, a final price for the first rider based on the upfront discount; and
determining, in response to determining that the carpool trip does not match with the at least one second rider, a final price for the first rider based on the fallback discount.

12. The system of claim 11, wherein the trip information comprises at least one of a time of the carpool trip, an origin region of the first rider in the carpool trip, a destination region the first rider in the carpool trip, a route of the carpool trip, a rider profile of the first rider, and points of interest.

13. The system of claim 11, wherein the fallback discount comprises a preset minimum discount.

14. The system of claim 11, wherein the upfront discount is determined based on the fallback discount, the matching probability, and an average discount.

15. The system of claim 11, wherein the upfront discount is personalized for the first rider by a personalized ride conversion model trained based on a plurality of historical trips.

16. The system of claim 15, wherein determining the upfront discount comprises:
generating, by the personalized ride conversion model, a price sensitivity curve comprising a conversion probability as a monotonically increasing function of discount; and
determining the upfront discount based on a targeted conversion probability and the price sensitivity curve.

17. The system of claim 11, wherein determining the matching probability comprises:
training a machine learning model based on a plurality of historical trips;
inputting features from the trip information into the trained machine learning model; and
determining the matching probability from the trained machine learning model based on the input features.

18. The system of claim 17, wherein determining the matching probability further comprises:
obtaining updated trip information during the carpool trip;
updating the matching probability periodically based on inputting the updated trip information into the trained machine learning model; and
updating the fallback discount based on the updated matching probability.

19. A non-transitory computer-readable storage medium configured with instructions executable by one or more processors to cause the one or more processors to perform operations comprising:
obtaining trip information of a first rider in a carpool trip on a ridesharing platform;
determining a matching probability of matching the carpool trip with at least one second rider;
determining an upfront discount and a fallback discount based on the matching probability and the trip information;
determining whether the at least one second rider matches with the carpool trip during the carpool trip;
determining, in response to determining that the carpool trip matches with the at least one second rider, a final price for the first rider based on the upfront discount; and
determining, in response to determining that the carpool trip does not match with the at least one second rider, a final price for the first rider based on the fallback discount.

20. The non-transitory computer-readable storage medium of claim 19, wherein the trip information comprises at least one of a time of the carpool trip, an origin region of the first rider in the carpool trip, a destination region the first rider in the carpool trip, a route of the carpool trip, a rider profile of the first rider, and points of interest.
